(19) United States
(12) Patent Application Publication
(10) Pub. No.: US 2003/0050788 A1
(43) Pub. Date: Mar. 13, 2003

(54) System and method for obtaining prices to maximize chargeback realization

(76) Inventor: Bruce A. Cranner, Metairie, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 09/949,538

(22) Filed: Sep. 7, 2001

(51) Int. Cl. G06F 17/60

(52) U.S. Cl. 705/1

(57) ABSTRACT

A method of determining the prices of a set of services or goods to be charged to a customer in order to optimize the amount for which the customer can obtain reimbursement from another for whose benefit the services or goods are purchased, comprising: categorizing by type the services or goods; ranking the categories by price sensitivity or chargeback realization; setting boundaries for a price increase, above a reference price associated with the services or goods in each category of a first subset of the categories and setting boundaries for a price decrease, below a reference price associated with the services or goods in each category of a second subset of the categories; and, increasing, above a reference price, the price of services or goods associated with each low price sensitivity or high chargeback realization category by an amount related to a decrease, below a reference price, of the price of services or goods associated with each high price sensitivity or low chargeback realization category, wherein the total charges to customer per period or basket of services or goods is less than or equal to the total charges to the customer based on the reference prices.

### CROSS-REFERENCE TO RELATED APPLICATIONS

Not applicable.

### COPYRIGHT STATEMENT

Not applicable.

### FEDERAL RESEARCH STATEMENT

Not applicable.

### FIELD OF THE INVENTION

The present invention relates to the field of pricing services and goods to optimize a customer's ability to increase chargeback realization.

### BACKGROUND OF THE INVENTION

Today's legal research providers use simple averaging to allocate dollars to services provided under a fixed price contract (e.g., if a customer uses 20 searches under a $100 per month contract, each search is priced at $5 for allocation and chargeback purposes ($100/20=$5)). While simple, such an allocation by the vendor is sub-optimal for most law firms to obtain maximum chargeback recovery from their clients. This is because most clients will only permit chargebacks on a few types of searches routinely performed by law firms (i.e., research and some unique searches. Most clients reject requests to reimburse firms for other types of searches, such as public records searches or news and document retrieval searches). Law firms absorb the costs of such searches as a component of the fixed price charge but recover by chargeback those charges allocated to research and allowed searches. This can amount to a large percentage of the allowed or apportioned searches under a fixed price contract, and can mean, for the legal service provider, substantial overhead in the form of unreimbursed charges.

There is no particular reason why legal research providers use the current allocation system except for its simplicity. There exists a need for a method and system to identify how to adjust prices for services and goods in order to optimize the ability of customers to obtain reimbursement from clients on whose behalf the services or goods were ordered. A need exists for increasing the percentage of chargeback realization.

### SUMMARY OF THE INVENTION

According to one aspect of the present invention, there is provided a method of optimizing chargeback realization. The method comprises raising prices on chargebacks for services that enjoy what economists call “low price sensitivity” among the clients of most law firms (this converts to high chargeback recovery from clients). Concurrently, prices/chargeback amounts for services that suffer from “high price sensitivity” among law firm clients can be lowered (i.e., lower prices/chargeback amounts for services with low chargeback recovery). This can be done in a way that allows the total amount of the fixed price contract to balance back to the provider's bill (or not, if that is required by the law firm). This should yield improved chargeback realization, meaning that the ratio of dollars paid by the law firm's clients divided by the total research costs incurred by the firm, will improve favorably to the law firm.

Legal research providers will be the principal users of this method and system. The providers must maintain control of the discounting process because law firms cannot add surcharges to costs pursuant to the 1993 American Bar Association Committee rulings regarding chargeback. The method and system, however, could also be used by internet service providers for their private and business subscribers to allow for discounted or flexible modified pricing programs based on usage. (i.e., by use of a code, the internet subscriber would prompt the price of specific use time to be established by the method, noted and billed back to the user for chargeback to the user's employer or for tax purposes). We also anticipate that any service provider who is restrained from marking up costs or chargebacks can use this method and system.

According to another aspect of the present invention there is provided a method of obtaining prices for legal research services that optimize the amount of reimbursement obtainable by a customer, comprising the acts of:

1) categorizing the types of legal research purchased by the type of practice areas or by the type of content (e.g., case law, statutes, public records searches, citatators, business/financial filings, etc.);

2) rank ordering these categories by increasing price sensitivity or percentage chargeback realization;

3) splitting the ranked list by categories where price rises are most feasible, and those where price rises are the least feasible (e.g., where chargeback realization is lowest);

4) setting boundaries for the range of price actions, preferably including a target for increase or decrease in price for each chargeback, and a floor and ceiling for the adjusted prices (e.g., no price or chargeback may fall below $0.00 per unit);

5) raising the price/chargeback of the least price sensitive service to the target, subject to: (a) the price ceiling for that service; and (b) not reducing the prices of the most price sensitive services (bottom half of the list) to less than their price floors in order to offset the price increase in the least price sensitive services;

6) increasing the price/chargeback of the second least price sensitive service to target, subject to: (a) the price ceiling for that service; and (b) not reducing the prices of the most sensitive services (bottom half of the list) to less than their price floors in order to offset the price increase in the least price sensitive services;

7) repeating for the third least price sensitive service, and for all other services in that portion of the list until the top half of the list is depleted.

Depending on the increases desired for the least price sensitive services, the bottom half of the list will see that most price sensitive service/category attain the lowest adjusted price first, and the second most price sensitive the second, and so on for the remainder of the list. The balancing of price increases with price decreases can be based on total charges, either per category or overall, or can be based on dollar for dollar price balancing, or on any alternative balancing method.

As an alternative, the method can be reversed. In the reversed mode, the chargeback of the most price sensitive service should be discounted to the lowest possible amount per unit (i.e., $0.00) with this number assigned as a ceiling for that service. Then, the second most price sensitive service can be discounted to an amount above the lowest possible amount, but far less than the maximum price (e.g., $0.05) with that price assigned as the ceiling for that service, and so on for the remainder of the list. This allows the price for the least price sensitive services to “float” below the overall price per unit ceiling.

### BRIEF DESCRIPTION OF THE DRAWINGS

Embodiments of the present invention are described by way of example only with reference to the accompanying drawings in which:

FIG. 1 is a flow chart illustrating the fundamental steps involved in the present method of obtaining prices to optimize chargeback realization; and

FIG. 2 is a block schematic diagram of a system for optimizing chargeback realization.

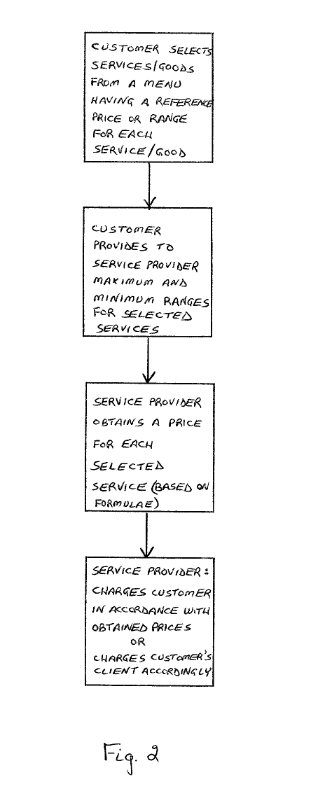

### DETAILED DESCRIPTION OF THE INVENTION

In the method according to one aspect of the present invention, the following symbols have meanings as indicated:

PR1 Price of a service or good that has lowest price sensitivity

PR2 Price of another service/good that has low price sensitivity

PRn Price of other services/goods that have low price sensitivity

PL1 Price of a service or good that has highest price sensitivity

PL2 Price of another service or good that has high price sensitivity

PLn Price of other goods or services that have high price sensitivity

S Bundled price or subscription for the above goods and services

Q A measure of monthly use, e.g., number of searches, number of minutes, number of any units, or all goods or services in the bundle S

QPR1 Number of units of good/service PR1 in bundle used/measured in a period of time

QPR2 Same as above for PR2

QPRN Same as above for Prn

QPL1 Same as above for PL1

QPL2 Same as above for PL2

QPLn Same as above for PLn

DPR1 Initial estimate, in percent or absolute numbers; it is desirable to raise the price or the chargeback amount for the good/service associated with PR1

DPR2 Initial estimate, in percent or absolute numbers; it is desirable to raise the price or the chargeback amount for the good/service associated with PR2

DPRn Initial estimate, in percent or absolute numbers; it is desirable to raise the price or the chargeback amount for the good/service associated with PRn

DPL1 Initial estimate, in percent or absolute numbers; it is desirable to lower the price or the chargeback amount for the good/service associated with PL1

DPL2 Same as above for PL2

DPLn Same as above for PLn

CPR1 Maximum amount to which the price or chargeback for the good/service associated with PR1 can be raised (usually above S/Q and below S)

CPR2 Same as above for PR2

CPRn Same as above for PRn

FPL1 Minimum price or chargeback amount which can be associated with PL1 (the “floor” usually below S/Q but greater than zero).

FPL2 Same as above for PL2

FPLn Same as above for PLn

IPR1 Improved or optimum price or chargeback amount for services/goods PR1

IPR2 Same as above for PR2

IPRn Same as above for PRn

IPL1 Same as above for PL1

IPL2 Same as above for PL2

IPLn Same as above for PLn

APR Amount of price rise

APL Amount of lowering

Intermediate terms are defined in accordance with the following equations:

APR=(PR1*DPR1*QPR1)+(PR2*DPR2*QPR2)+(PRn*DPRn*QPRn)

APL=((PL1-FPL1)*QPL1)+((PL2-FPL2)*QPL2)+((PLn-FPLn)*QPLn)

Solutions to the pricing problem are calculated as follows:

IPR1=Lowest of the following:

PR1*DPR1 and CPR1 and (APL/QPR1)+PR1

IPR2=Lowest of the following:

PR2*DPR2 and CPR2 and [APL-((IPR1-PR1)*QPR1)/QPR2]+PR2

IPRn=Lowest of the following:

PRn * DPRn and CPRn and [APL-(((IPR1-PR1)*QPR1)+((IPR2-PR2)*QPR2))/QPRn[+Prn]

IPL1=Highest of the following:

PL1*DPL1 and FPL1 and (APR/QPL1)+PL1

ILP2=Highest of the following:

PL2*DPL2 and FPL2 and [APR-((IPL1-PL1)*QPL1)/QPL2]+PL2

IPLn=Highest of the following:

PLn*DPLn and FPLn and [APR-(((IPL1-PL1)+((IPR2-PR2)*QPL2))/QPLn]

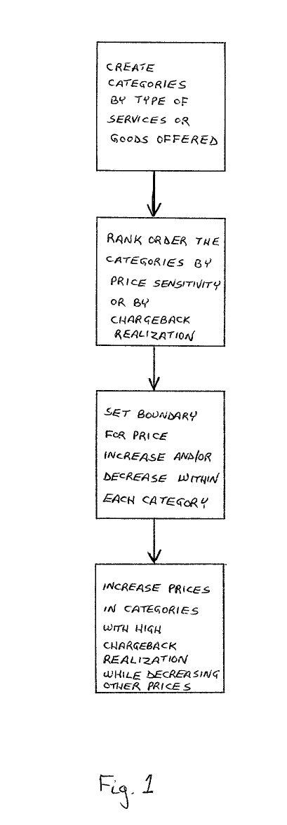

Referring to FIG. 1, a method of obtaining prices of services or goods to optimize chargeback realization is shown according to one embodiment of the present invention. Reference prices PR1, PR2, . . . PRn are obtained for each of a series of services or goods that have low price sensitivity, where PR1 is the price for a service or good having the lowest price sensitivity, PR2 is the price of a service or good having the next lowest price sensitivity, and so on in order of increasing price sensitivity. Concomitantly, PL1, PL2, . . . PLn are obtained for each of a series of services or goods that have high price sensitivity. Each service or good is placed onto a category depending upon price sensitivity. Preferably, the categories are range ordered in order of price sensitivity, or in order of chargeback realization. Preferably the categories are placed into two subsets, an upper subset consisting of the categories containing the least price sensitive or highest chargeback realization services or goods, and a lower subset consisting of the categories containing the highest price sensitivity or lowest chargeback realization services or goods. The subsets contain approximately equal numbers of categories.

Boundaries for price changes are obtained or designated, either by the service provider or by the customer. At least one boundary is usually established for each. A service provider can provide a single reference price for each service, a range of prices around a reference price, or no reference price at all. A customer can provide a range around a reference price, i.e., maximum and minimum price ranges, either a percentage or in monetary amounts.

Once a boundary is obtained, the price of services or goods within an upper subset category is increased, while the price of services or goods within a lower subset category is decreased. The price increase in an upper subset category is determined by a price decrease in an associated lower subset category. Preferably the lower boundary for a price decrease is zero, but in some circumstances a positive or even a negative price could be selected.

Preferably, the upper subset category having the lowest price sensitivity or the highest chargeback realization is associated with the lower subset category having the highest price sensitivity or the lowest chargeback realization. Also preferably, each successive category by rank in the upper subset is associated with a successive category by rank in the lower subset until an upper boundary of prices associated with all categories in the upper subset is obtained.

The method can be used so that the total charges to a customer per time period or per basket of services or goods is less than or equal to the total charges to the customer based on reference prices.

The invention now being fully described, it will be apparent to one of ordinary skill in the art that many changes and modifications can be made therein without departing from the spirit or scope of the appended claims.

What is claimed is:

1. A method of obtaining prices to be charged to a customer for services or goods in order to optimize the amount of reimbursement obtainable by a customer from another who benefits from the customer's purchase of the services or goods, the method comprising the acts of:
(a) creating categories by type of services or goods to be offered to a customer;
(b) creating a rank-ordered set of the categories by price sensitivity of the services or goods associated with each category;
(c) setting a boundary for a price change relative to a reference price of the services or goods within each category;
(d) increasing, subject to an upper boundary, the price of services or goods contained within a category containing low price sensitive services or goods and decreasing, subject to a lower boundary, the price of services or goods contained within a category containing more price sensitive goods.

2. A method of obtaining prices to be charged to a customer for services or goods in order to optimize the amount of reimbursement obtainable by a customer from another who benefits from the customer's purchase of the services or goods, the method comprising the acts of:
(a) creating categories by type of services or goods to be offered to a customer;
(b) creating a rank-ordered set of the categories by chargeback realization of the services or goods associated with each category;
(c) setting a boundary for a price change relative to a reference price of the services or goods within each category;
(d) increasing, subject to an upper boundary, the price of the services or goods within a category containing a high percentage chargeback realization, and decreasing, subject to a lower boundary, the price of services or goods within a category containing a low percentage chargeback realization.

3. The method according to claim 1 or 2, wherein the rank-ordered set of categories is split into subsets, an upper subset and a lower subset, the lower subset consisting of the categories containing services or goods having relatively high price sensitivity or relatively low chargeback realization, and the upper subset consisting of the categories containing services or goods having relatively low price sensitivity or relatively high chargeback realization.

4. The method according to claim 1 or 2, wherein the lower boundary of prices is zero.

5. The method according to claim 1 or 2, wherein the upper boundary of the increase in price of the services or goods, contained within the category containing the least price sensitive or the highest chargeback realization services or goods, is determined by a decrease in price, subject to the lower boundary, of the services or goods contained within the category containing the most price sensitive or the lowest chargeback realization services or goods.

6. The method according to claim 3, wherein the upper boundary of the increase in prices of the goods or services contained within each upper subset category is determined by an associated decrease, subject to a lower boundary, of the prices of the goods and services contained within an associated lower subset category.

7. The method according to claim 6, wherein the category containing services or goods having the lowest price sensitivity or the highest chargeback realization is associated with the category containing services or goods having the highest price sensitivity or the lowest chargeback realization, the category containing services or goods having the second-lowest price sensitivity or the second-highest chargeback realization is associated with the category containing services or goods have the second-highest price sensitivity or the second-highest chargeback realization, and each successive category in the upper subset of categories is associated with a successive category in the lower subset of categories until an upper boundary of prices associated all categories in the upper subset is obtained.

8. A method of determining the prices of a set of services or goods to be charged to a customer in order to optimize the amount for which the customer can obtain reimbursement from another for whose benefit the services or goods are purchased, the method comprising the acts of:
(a) categorizing by type the services or goods;
(b) ranking the categories by price sensitivity or chargeback realization;
(c) setting boundaries for a price increase, above a reference price associated with the services or goods in each category of a first subset of the categories and setting boundaries for a price decrease, below a reference price associated with the services or goods in each category of a second subset of the categories;
(d) increasing, above a reference price, the price of services or goods associated with each low price sensitivity or high chargeback realization category by an amount related to a decrease, below a reference price, of the price of services or goods associated with each high price sensitivity or low chargeback realization category, wherein the total charges to customer per period or basket of services or goods is less than or equal to the total charges to the customer based on the reference prices.
